(19) United States
(12) Patent Application Publication
(10) Pub. No.: US 2008/0139713 A1
(43) Pub. Date: Jun. 12, 2008

(54) Processing Aid For Pvc and Method For Manufacturing the Same

(75) Inventors: Kyung-woo Lee, Daejeon (KR); Yang-seung Jeong, Daejeon (KR); Hyun-chul Ha, Gyeonggi-do (KR)

Correspondence Address: MCKENNA LONG & ALDRIDGE LLP, 1900 K STREET, NW, WASHINGTON, DC, 20006, US

(73) Assignee: LG CHEM, LTD., Youngdungpo-gu, Seoul (KR)

(21) Appl. No.: 11/665,174

(22) PCT Filed: Dec. 8, 2005
(86) PCT No.: PCT/KR2005/004203

§ 371 Date: Apr. 12, 2007

(30) Foreign Application Priority Data
Dec. 8, 2004 (KR) 10-2004-0102930
May 31, 2005 (KR) 10-2005-0046148

(51) Int. Cl. C08K 13/04; C08K 5/101; C08K 5/521; C08K 9/10; C08K 5/092

(52) U.S. Cl. 524/139; 524/560; 524/524; 524/296; 524/300; 524/295; 524/366

(57) ABSTRACT

Disclosed is a processing aid for vinyl chloride resin containing a plasticizer or an internal lubricant for vinyl chloride resin within methyl methacrylate-based polymer particles; and a method of manufacturing the same. The processing aid according to the present invention containing the plasticizer or the internal lubricant increases a melting rate of the vinyl chloride resin when compared to the conventional processing aid including a methyl methacrylate-based polymer alone, thereby improving the processibility and properties of the vinyl chloride resin.

### TECHNICAL FIELD

The present invention relates to a processing aid used for vinyl chloride resin and a method for manufacturing the same, and more particularly to a processing aid capable of improving processability and physical properties of vinyl chloride resin by mixing and polymerizing a monomer, a plasticizer or an internal lubricant, an emulsifier, an initiator and deionized water using a miniemulsion-polymerization to manufacture a plasticizer or a processing aid having an internal lubricant as a latex particle form and this is provided to a process for manufacturing vinyl chloride resin; and a method for manufacturing the same.

### BACKGROUND ART

Generally, vinyl chloride resins have advantages that they are inexpensive and have excellent physical, chemical and electrical properties, and also satisfy a wide range of physical properties of soft to hard products by suitably controlling a prescription thereof. Accordingly, the vinyl chloride resins are widely used for a wide range of products such as films, seats, automobile interior materials, pipes, window frames, vessels, and decoration materials. However, the vinyl chloride resins have disadvantages that they have poor heat resistance and impact resistance and low processibility. The vinyl chloride resins are molded by two kinds of energy, i.e. energy from a mechanical shear force transferred from a processing machine, and external thermal energy, wherein the molding should be carried out so that an internal temperature of the resins can be maintained within a certain range. It is why if the resins are processed at a temperature out of the certain range, the resins themselves are thermally decomposed, resulting in a lot of problems such as poor physical properties of the products and the polluted environment since a thermal decomposition temperature of the PVC resins is near to their processing temperature.

The vinyl chloride resins may sufficiently exhibit original properties themselves if they are processed in the melted status wherein boundaries of primary grains constituting basal grains of the resins disappear and molecules of the resins are blended uniformly. However, the vinyl chloride resins have problems that it essentially takes a very long time to be completely melted, and therefore if a molding process is completed before the vinyl chloride resins are completely melted, the final products have deteriorated physical properties such as impact resistance, moldability and mechanical properties, and values of the final products are reduced due to rough product surfaces. It is called as a processing aid which improves the problems i.e. the delayed melting property of the vinyl chloride resins and helps the vinyl chloride reins fully exhibit overall mechanical and chemical properties, and the processing aid is necessarily used in a process of the vinyl chloride reins. The processing aid is generally added in a quantity of 1 to 5 parts by weight-based on 100 parts by weight of the vinyl chloride resin so as to improve processability of the vinyl chloride resins so that it can fully exhibit the excellent physical properties of the vinyl chloride resins.

For example, the processing aid added to the vinyl chloride resin plays roles to improve bank rolling and flow marks, and reduce air streaks and surface roughness when the resin is processed using a calendar. Further, even when the vinyl chloride resins are processed to produce foamed plastic products, they serve to help melting of the vinyl chloride resin be progressed enough to form walls of air cells, thereby enhancing melt strength, and help the vinyl chloride resin endure pressure of the air decomposed and expanded at a high temperature, thereby preventing open cells from being formed, wherein the open cells are connected with each other when the air cells are burst. Still further, it serves to enhance break strength and elongation at high temperature upon a vacuum or blow molding.

Such effects allows the processing aid to break the boundaries of the basic component units, primary grains, of the vinyl chloride resin at an early period upon molding the vinyl chloride, thereby promoting their uniformly molten status in a molecular level to obtain a molded product having uniform mechanical and chemical properties.

Now, most of the commercially available processing aids are a high molecular weight polymer comprising as a main monomer only methacrylate having an excellent compatibility with a vinyl chloride resin, or a methyl methacrylate-based polymer composed of methyl methacrylate monomer as a main component; and a high molecular weight (Mw: 500,000 to 5,000,000 g/mole) polymer, as an auxiliary component, obtained by emulsion-copolymerizing a small quantity of an acrylate, methacrylate, or nitrile-based unsaturated compound having an double bond or an aromatic monomer containing an double bond.

Meanwhile, the plasticizer is made of a non-volatile material, and therefore it is added to the vinyl chloride resin to increase fluidity, resilience and adhesiveness, thereby to enhance the processiblity of the vinyl chloride resin. Further, the plasticizer gives the flexibility to the products made of the vinyl chloride resin and converts a hard and glassy solid material to a flexible and strong material by lowering a melting point of the resin. Still further, the plasticizer is added to a polymer to improve the processibility of the polymer and converts the physical property of the polymer. If the plasticizer is added to a polymer resin, the plasticizer is infiltrated between molecules of the resin to break strong bonds formed between the molecules of the resin, resulting in formation of bonds between molecules of the resin and molecules of the plasticizer. That is, the plasticizer functions as a lubricant between the molecules of the resin when the strong bonds are broken between the molecules of the resin. Further, resistance against modification of amorphous polymers is caused due to three-dimensional cross-linking structure of the molecules, and therefore the plasticizer facilitates modification of polymers by selectively releasing a stress between the polymers.

However, if a small quantity of plasticizer is added to a polymer, a free space in the polymer is filled with the plasticizer, resulting in an antiplasticization phenomenon. That is, a glass transfer temperature of the polymer is lowered, a tensile strength and a tensile resilient are enhanced, and elongation rate and impact strength are reduced. In the conventional plasticizers, an antiplasticization concentration is about 5 to 10% according to a type of the plasticizer. Accordingly, if the plasticizer is used in the antiplasticiation concentration, it is not avoidable to deteriorate physical properties of the resin product since the plasticizer does not aid to melt the polymer even though it lowers the glass transfer temperature of the vinyl chloride resin and increases the processibility of the resin.

The lubricant plays a role to reduce an excessive friction between polymer chains (an internal lubricant), or a friction between a polymer and a processing machine (an external lubricant) upon processing the polymer. If the lubricant is not added when the vinyl chloride resin is processed, then a frication is locally caused to increase a temperature of a mold over the thermal modification temperature of the vinyl chloride resin. As a result, a deformation such as pigmentation may occur, and therefore it is more difficult to conduct a uniform molding process. Further, in the different respect, as the friction between the processing machine and the resin becomes increased, the resin sticks to the processing machine, resulting in difficulty in thermal modification or formation of uniform resin composition.

### DISCLOSURE OF INVENTION

An aspect of the present invention is to solve at least the above problems and/or disadvantages and to provide at least the advantages described below. Accordingly, an aspect of the present invention is to provide a novel processing aid capable of greatly improving the processibility of a vinyl chloride resin when compared to currently used processing aids by mixing a processing aid and a plasticizer to maximize an effect of the methyl methacrylate-based polymer, wherein a processing aid/polymer complex is manufactured using a specific method, and the processing aid/polymer complex includes the plasticizer or internal lubricant in the polymer used as the processing aid; and a method for manufacturing the same.

These and other objects of the present invention may be all attained referring to preferred embodiments of the present invention.

According to one embodiment of the present invention, there is provided the processing aid containing a plasticizer or an internal lubricant for vinyl chloride resin in methyl methacrylate-based polymer particles.

The processing aid for vinyl chloride resin may be polymethylmethacrylate.

The processing aid for vinyl chloride resin can further include a polymer obtained by copolymerizing a monomer having unsaturated double bonds with a monomer of methylmethacrylate.

The plasticizer can be used at an quantity of 5 to 900 parts by weight, based on 100 parts by weight of the processing aid.

The processing aid may have a particle size of 100 to 1500 nm.

The molecular weight of the processing aid may range from 100,000 to 10,000,000.

According to another embodiment of the present invention, there is provided a method for manufacturing a processing aid, including steps of mixing and homogenizing a monomer having unsaturated double bonds and capable of being polymerized by free radicals, a ultrahydrophobe, a plasticizer or an internal lubricant, an emulsifier, an initiator and deionized water so as to obtain a miniemulsion; and polymerizing the miniemulsion by heating.

According to further another embodiment of the present invention, there is provided a method for manufacturing a processing aid, including steps of mixing and homogenizing a monomer having unsaturated double bonds and capable of being polymerized by free radicals, a plasticizer or an internal lubricant, an emulsifier, an initiator and deionized water so as to obtain a miniemulsion; and polymerizing the miniemulsion by heating, wherein the plasticizer or the internal lubricant has a solubility in water of 5×10⁻⁶ g/g or less at 25° C.

The miniemulsion may further include a copolymer monomer copolymerizable with the monomer in the step of obtaining the miniemulsion.

The homogenizing step is performed by using a microfluidizer, an ultrasonifier, a Manton-Gaulin homogenizer or an omni-mixer.

The miniemulsion may have a particle size of 100 to 1600 nm.

The miniemulsion can include 5 to 900 parts by weight of the plasticizer or the internal lubricant, 0.05 to 3 parts by weight of the emulsifier, 0.01 to 0.3 parts by weight of the initiator, 100 and 500 parts by weight of the distilled water, based on 100 parts by weight of the monomer. The ultrahydrophobe may be less than 10 parts by weight, based on 100 parts by weight of the monomer.

The monomer that has unsaturated double bonds and is polymerized by free radicals may be selected from the group consisting of methacrylate derivatives, acrylate derivatives, acrylic derivatives, methacrylonitrile derivatives, styrene, styrene derivatives, acrylonitrile derivatives, vinylester derivatives, halogenized vinyl butadiene derivative, isoprene, maleic anhydride, and fumaric acid.

The emulsifier may be at least one material selected from the group consisting of anionic emulsifiers, cationic emulsifiers and nonionic emulsifiers.

The initiator may be at least one material selected from the group consisting of persulfate-based initiators, peroxide, peroxide-based initiators, azo-based initiators and redox initiators.

The ultrahydrophobe has a solubility in water of 5×10⁻⁶ g/g or less at 25° C., and may be at least one material selected from the group consisting of aliphatic hydrocarbons having C₁₂ to C₂₀ carbon atoms, aliphatic alcohols having C₁₂ to C₂₀ carbon atoms, acrylate composed of alkyl groups having C₁₂ to C₂₀ carbon atoms, mercaptan having C₁₂ to C₂₀ carbon atoms, organic dyes, fluorinated alkane, silicon oils, natural oils, synthetic oils, oligomers having a molecular weight of 1,000 to 500,000, and polymers having a molecular weight of 1,000 to 500,000.

The plasticizer can be selected from the group consisting of phthalate derivatives having C₃ to C₂₀ carbon atoms, fatty acid derivatives having C₃ to C₂₀ carbon atoms, mellitate derivatives having C₃ to C₃₀ carbon atoms, phosphate derivatives having C₁ to C₂₀ carbon atoms, epoxy derivatives, soybean oils, and polyethylene derivatives.

The phthalate derivative derivatives having C₃ to C₂₀ carbon atoms can be selected from the group consisting of di(2-ethylhexyl) phthalate, di(n-octyl) phthalate, diiosononyl phthalate, diisodecyl phthalate, dimethyl phthalate, diethyl phthalate, diisobutyl phthalate, dibutyl phthalate, diheptyl phthalate, dinonyl phthalate, ditridecyl phthalate, butylbenzyl phthalate and butylphthalyl butylglycolate; the fatty acid ester derivatives having C₃ to C₂₀ carbon atoms can be selected from the group consisting of dioctyl adipate, diisononyl adipate, diisodecyl adipate, dioctyl azelate, dioctyl cebacate, methylacetylicinolate, dibutylglycol adipate, di(2-ethylhexyl)malate, dibutyl malate, dibutylacetyl fumarate, acetyltriethyl citrate, acetyl 2-ethylhexyl citrate, triethyl citrate, acetyltributyl citrate and acetyltriethyl citrate; the mellitate derivatives having C₃ to C₃₀ carbon atoms can be selected from the group consisting of trioctyl mellitate and triisodecyl mellitate; the phosphate derivatives having C₁ to C₂₀ carbon atoms can be selected from the group consisting of triceresyl phosphate, triphenyl phosphate, trioctyl phosphate, triisopropyl phosphate, tribetachloroethyl phosphate, octyldiphenyl phosphate and tridichloropropyl phosphate; and the epoxy derivatives can be selected from the group consisting of epoxy fatty acid ester and epoxylated grease derivatives.

The internal lubricant can be selected from the group consisting of fatty acid ester-based derivatives, fatty acid-based derivatives and their metal salts having C₁₀ to C₂₀ carbon atoms, fatty acid alcohols and their metal salts having C₆ to C₂₀ carbon atoms, ester compounds of polyol and fatty acid, each their having C₁₀ to C₂₀ carbon atoms, and fatty acid amid derivatives having C₁₀ to C₂₃ carbon atoms. They may be used alone or in combination thereof.

The method for manufacturing a processing aid of the present invention may further include a step of forming dried particles using a spray-drying method after the step of polymerizing a miniemulsion by heating, or coagulating and drying a miniemulsion to remove moisture.

Hereinafter, the present invention is described with reference to examples below, but is not limited to the examples.

The present invention relates to a processing aid in a latex form having an improved processability when compared to conventional processing aids manufactured by adding and mixing a processing aid, and a plasticizer or an internal lubricant, by incorporating plasticizer or an internal lubricant into internal cavities of the processing aid using a miniemulsion method.

The present invention provides a method for manufacturing the processing aid including steps of adding a plasticizer to a methyl methacrylate polymer, which gives a shearing force to a vinyl chloride resin by means of adhesion, to lower a glass transfer temperature of a processing aid polymer, and combining a plasticizer or an internal lubricant, and a processing aid polymer into one particle. The plasticizer lowers a glass transfer temperature of an acrylate-based polymer, thereby promoting adhesion of the vinyl chloride resin around the methyl methacrylate-based polymer.

A processing aid containing the plasticizer or the internal lubricant may be manufactured using the following components:

(a) based on 100 parts by weight of a monomer

(b) 5 to 900 parts by weight of a plasticizer or an internal lubricant

(c) 0 to 10 parts by weight of an ultrahydrophobe

(d) 0.05 to 3 parts by weight of an emulsifier

(e) 0.01 to 0.3 parts by weight of an initiator; and

(f) 100 to 500 parts by weight of deionized water

The components weighed thus are mixed, and the mixture is homogenized until it has a particle size of 100 to 2000 nm by using a microfluidizer, an ultrasonifier, a Manton-Gaulin homogenizer or an omni-mixer. The homogenized mixture is put into a polymerization reactor, heated to a temperature of 50 to 100° C. according to the final purpose, and then polymerized to obtain a latex. The resultant latex is subject to a powdering process such as a coagulation method or a spray-drying method to obtain powder of the processing aid.

The monomer includes 50 to 100% by weight of methyl methacrylate as a main component and an auxiliary component copolymerizable with the main component by free radicals. The auxiliary component is, but not limited to, selected from the group consisting of methacryl- or acryl-based monomers such as ethyl acrylate, hydroxyethyl methacrylate, n-butyl methacrylate, isobutyl acrylate, isobutyl methacrylate, n-hexyl acrylate, n-hexyl methacrylate, ethylhexyl acrylate, ethylhexyl methacrylate, n-octyl acrylate, n-octyl methacrylate, decyl acrylate, decyl methacrylate, dodecyl acrylate, dodecyl methacrylate, stearyl acrylate, stearyl methacrylate, cyclohexyl acrylate, cyclohexyl methacrylate, 4-tert-butylcyclohexyl methacrylate, benzyl acrylate, benzyl methacrylate, phenylethyl acrylate, phenylethyl methacrylate, pehylpropyl acrylate, pehylpropyl methacrylate, phenylnonyl acrylate, phenylnonyl methacrylate, 3-metoxybutyl acrylate, 3-metoxybutyl methacrylate, butoxyethyl acrylate, butoxyethyl methacrylate, diethylene glycol monoacrylate, diethylene glycol monomethacrylate, triethylene glycol monoacrylate, triethylene glycol monomethacrylate, tetraethylene glycol monoacrylate, tetraethylene glycol monomethacrylate, furfuryl acrylate, and furfuryl methacrylate; nitrile-based monomers such as acrylonitrile and methacrylonitrile; aromatic monomers having unsaturated double bonds such as styrene, alpha-methylstyren and vinyl toluene, and other monomers copolymerizable with methyl methacrylate. They may be used alone or in combination thereof.

The plasticizer includes at least one material, but not limited to, selected from the group consisting of phthalate derivatives having C₃ to C₂₀ carbon atoms, fatty acid ester derivatives having C₃ to C₂₀ carbon atoms, mellitate derivatives having C₃ to C₃₀ carbon atoms, phosphate derivatives having C₁ to C₂₀ carbon atoms, epoxy derivatives, soybean oils, and polyethylene derivatives. The phthalate derivatives having C₃ to C₂₀ carbon atoms include di(2-ethylhexyl)phthalate, di(n-octyl)phthalate, diiosononyl phthalate, diisodecyl phthalate, dimethyl phthalate, diethyl phthalate, diisobutyl phthalate, dibutyl phthalate, diheptyl phthalate, dinonyl phthalate, ditridecyl phthalate, butylbenzyl phthalate and butylphthalylbutyl glycol. The fatty acid ester derivatives having C₃ to C₂₀ carbon atoms include dioctyl adipate, diisononyl adipate, diisodecyl adipate, dioctyl azelate, dioctyl cebacate, methylacetylicinolate, dibutylglycol adipate, di(2-ethylhexyl)malate, dibutyl malate, dibutylacetyl fumarate, acetyltriethyl citrate, acetyl 2-ethylhexyl citrate, triethyl citrate, acetyltributyl citrate and acetyltriethyl citrate. The mellitate derivatives having C₃ to C₃₀ carbon atoms include trioctyl mellitate and triisodecyl mellitate. The phosphate derivatives having C₁ to C₂₀ carbon atoms include triceresyl phosphate, triphenyl phosphate, trioctyl phosphate, triisopropyl phosphate, tribetachloroethyl phosphate, octyldiphenyl phosphate and tridichloropropyl phosphate. The epoxy derivatives include epoxy fatty acid ester and epoxylated grease derivatives. They may be used alone or in combination thereof.

The plasticizer or the internal lubricant is preferably added in a quantity of 5 to 900 parts by weight, based on 100 parts by weight of the monomer. If quantity of the plasticizer is less than 5 parts by weight, the processing aid including the plasticizer exhibits a low effect, while if quantity of the plasticizer exceeds 900 parts by weight, it is difficult to form a polymerization composition since it is difficult to form particles.

The ultrahydrophobe has a solubility in water of 5×10⁻⁶ g/g or less at 25° C., and may be selected from the group consisting of aliphatic alcohols having C₁₂ to C₂₀ carbon atoms, acrylate composed of alkyl groups having a C₁₂ to C₂₀ carbon atoms, alkyl mercaptan having a C₁₂ to C₂₀ carbon atoms alone or in combination thereof, organic dyes, fluorinated alkane, silicon oils, natural oils and synthetic oils. If the plasticizer has a solubility in water of 5×1⁻⁶ g/g or less at 25° C., the plasticizer can act as an ultrahydrophobe needed in the step of forming miniemulsion. Accordingly, the ultrahydrophobe may not be added, if necessary. The ultrahydrophobe may be, but not limited to, at least one material selected from the group consisting of hexadecane, heptadecane, octadecane, cetyl alcohol, isopropyl laurate, isopropyl palmitate, hexyl laurate, isopropyl myristate, myristyl myristate, cetyl myristate, 2-octyldecyl myristate, isopropyl palmitate, 2-ethylhexyl palmitate, butylstearate, decyl oleate, 2-octyldodecyl oleate, glycolester oil such as polypropylene glycol monooleate, neopentyl glycol 2-ethylhexanoate and glycol ester oil, isostearate, triglyceride, coco fatty acid triglyceride, almond oil, apricot kernel oil, avocado oil, theobroma oil, carrot seed oil, caster oil, orange seed oil, coconut oil, corn oil, cottonseed oil, cucumber oil, egg oil, jojoba oil, lanolin oil, flax seed oil, mineral oil, mink oil, olive oil, palm oil, human milk, peach seed oil, peanut oil, rapeseed oil, safflower oil, sesame oil, shark liver oil, soybean oil, sunflower seed oil, sweet almond oil, beef tallow, mutton tallow, turtle tallow, vegetable oil, whale oil, wheatgerm oil, organic silicon, syloxane, alkyl mercaptan such as n-dodecyl mercaptan and t-todecyl mercaptan, fluorinated alkane such as hexa fluorine benzene. They may be sued alone or in combination thereof.

The emulsifier may be at least one material selected from the group consisting of anionic emulsifiers, cationic emulsifiers and nonionic emulsifiers. That is to say, the emulsifier may be, but not limited to, selected from the group consisting of the anionic emulsifiers widely used in the emulsion polymerization such as sulfonate-based, carboxylate-based, succicinate-based, and sulfosuccinate and its metal salts, for example alkyl benzene sulfonic acid, sodium alkyl benzene sulfonate, alkylsulfonic acid, sodium alkylsulfonate, sodium polyoxyethylene nonylphenylether sulfonate, sodium stearate, sodium dodecyl sulfate, sodium lauryl sulfate, sodium dodecyl sulfosuccinate, and abietic acid salt; the cationic emulsifiers having aminehalides, quaternary alkyl ammonium salts and alkyl pyridinium salts connected as functional groups of higher aliphatic hydrocarbons; and the nonionic emulsifiers such as polyvinylalcohols and polyoxyethylenenonylphenyl. However, the emulsifiers in this invention are not limited to the above materials. They may be used alone or in combination thereof.

The initiator may be suitably used if it may generate free radicals. A representative example of the initiator may be, but not limited to, at least one material selected from the group consisting of peroxide-based compounds, azo-based compounds, and redox compounds consisting of combination(s) of oxidation/reduction-based compounds.

It is impossible to obtain polymer latex containing a plasticizer or an internal lubricant therein by conventional emulsion polymerizations, known as general methods for manufacturing a processing aid. That is, during the emulsion polymerization, monomers are supplied by diffusion in the presence of water from large particles made of a monomer mixture. However, since the internal lubricant having a low solubility in water and a relatively large molecular weight diffuses at a relatively slower rate than that of other monomers, the internal lubricant can not move enough during the polymerization. Accordingly, the added plasticizer or the internal lubricant becomes instable during the polymerization, thereby generating a lot of agglomerates. That is, it is difficult to obtain the processing aid in which the plasticizer or the internal lubricant is integrally formed. Accordingly, a miniemulsion polymerization is used in the present invention.

In this miniemulsion polymerization method, the ultrahydrophobe plays a very important role. However, the plasticizer or the internal lubricant may be used as the ultrahydrophobe if it has a very low solubility in water. At this time, the processing aid into which the plasticizer or the internal lubricant is integrally introduced may be manufactured without using the ultrahydrophobe since the plasticizer or the internal lubricant acts as the ultrahydrophobe.

The processing aid latex manufactured thus is dispersed in a liquid phase, and therefore moisture should be removed from the processing aid latex upon its use. Methods of removing the moisture include a spray-drying method, and a coagulation-drying method. The spray-drying method is preferably easily used because it can dry a large volume of latex with a small energy.

The method for coagulating an emulsion-polymerized latex is generally used under a coagulation condition, as follows. The latex is heated to 60 to 100° C., and a water-soluble multivalent metal salt is added in a quantity of 0.01 to 5 parts, based on the latex, and then heated at a temperature ranging from the glass transfer temperature to a temperature higher than the glass transfer temperature by 30° C. for 30 minutes to 2 hours. The resultant particles are filtrated, and then water and coagulated electrolyte solution are removed off to obtain a wet cake. The wet cake is dried by hot air or a fluid bed dryer to obtain a processing aid without any of moisture.

A gelation time of the vinyl chloride resin processed with the processing aid manufactured thus is measured as a function of its properties.

Here, the term “gelation time” means a time until a point where primary particles of the vinyl chloride resin are completely melted into a molecular level of a uniform mixture after losing properties of the particles by a shear force of the vinyl chloride resin and a thermal energy. A typical melting curve of the vinyl chloride resin is shown in FIG. 3. Referring to FIG. 3, the vinyl chloride resin exist in the form of particle at an initial stage, but partial dissolution-friction-sticking of the particles are sequentially progressed by energies generated by the heat or shear force, and simultaneously processing load is increased by resistance exerted to the processing machine. The vinyl chloride resin is continuously subject to the shear force and thermal energy, and decomposed into polymer chains. At this time, the vinyl chloride resin is suddenly gelated when particles are changed into a gel state. That is, the gelation time is referred to as a time that it takes to convert the vinyl chloride resin into the gel state.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a TEM photograph showing a processing aid containing a plasticizer manufactured according to one embodiment of the present invention;

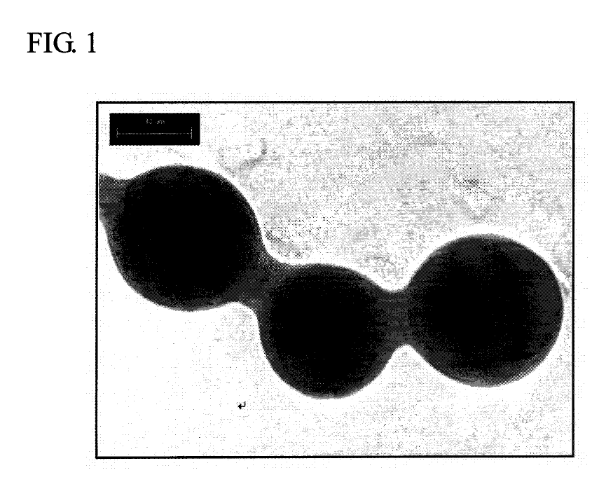

FIG. 2 is a TEM photograph showing a processing aid containing an internal lubricant manufactured according to one embodiment of the present invention;

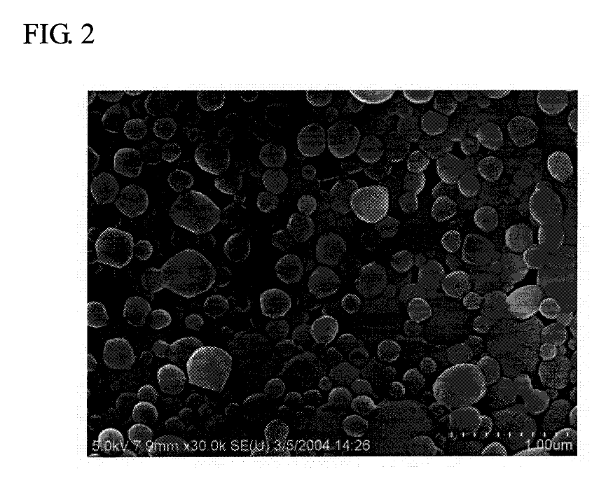

FIG. 3 is a schematic view illustrating the operation of a vinyl chloride resin and the processing aid; and

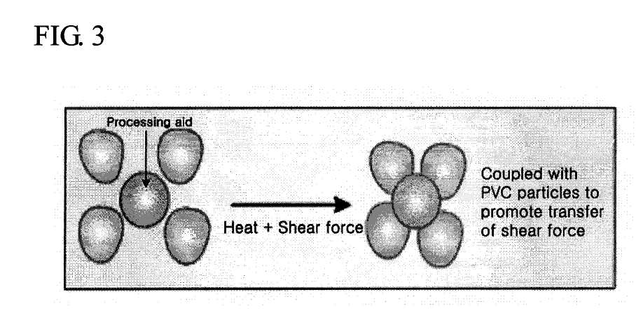

FIG. 4 is a graph illustrating a gelation curve for a vinyl chloride resin with the time-torque relationship when the vinyl chloride resin is gelated.

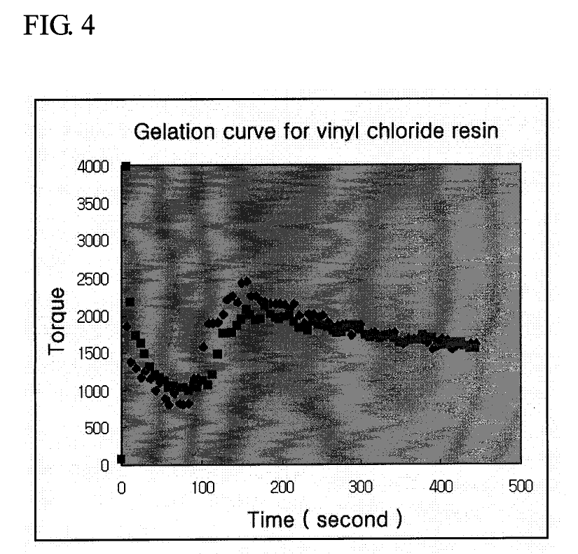

### BEST MODES FOR CARRYING OUT THE INVENTION

Hereinafter, embodiments of the present invention will be described in detail, but the present invention is not limited to the embodiments

Preparation of a Processing Aid Containing a Plasticizer

Components as in the following table 1 are blended and polymerized to obtain a polymer latex, and the resultant polymer latex is spray-dried or coagulation-dried to manufacture a processing aid containing a plasticizer, (hereinafter, referred to “PEP”). A prescription for obtaining the processing aid containing the plasticizer is listed in table 1.

TABLE 1

| | | Composition (Parts by weight) | | | | | | | |
|---|---|---|---|---|---|---|---|---|---|
| | | PEP1 | PEP2 | PEP3 | PEP4 | PEP5 | PEP6 | PEP7 | PEP8 |
| Monomer | Methyl | 100 | 100 | 100 | 100 | 100 | 100 | 100 | 100 |
| | Methacrylate | | | | | | | | |
| Plasticizer | Dioctyl Phthalate | 100 | 100 | 100 | — | — | — | 10 | 100 |
| | Trioctyl | — | — | — | 100 | 50 | — | — | — |
| | Phthalate | | | | | | | | |
| | Diisonyl | — | — | — | — | — | 100 | — | — |
| | Phthalate | | | | | | | | |
| Ultrahydrophobe | Hexadecane | — | 3 | 5 | — | 3 | — | — | — |
| Lubricant | Sodium | 0.3 | 0.2 | 0.1 | 0.2 | 0.2 | 0.2 | 0.2 | 0.2 |
| | Laurylsulfate | | | | | | | | |
| Initiator | Laurylperoxide | 0.1 | 0.1 | 0.1 | 0.1 | 0.1 | 0.1 | 0.05 | 0.05 |

| | | | | | | | | |
|---|---|---|---|---|---|---|---|---|
| Deionized Water | 500 | 500 | 500 | 500 | 500 | 500 | 500 | 500 |
| Polymerization Temperature (° C.) | 70 | 70 | 90 | 90 | 80 | 90 | 70 | 70 |
| Number-average | 120 | 125 | 70 | 68 | 90 | 89 | 121 | 123 |
| Molecular weight (×10⁴) | | | | | | | | |
| Particle size (nm) | 250 | 365 | 500 | 380 | 370 | 366 | 340 | 338 |

Preparation of a Processing Aid Containing an Internal Lubricant

A polymer latex is obtained by polymerizing components as in the following table 2, and then the polymer latex is spray-dried or coagulation-dried to manufacture a processing aid containing an internal lubricant (hereinafter, referred to “PLP”). A prescription for obtaining the processing aid containing the internal lubricant is shown in table 2.

TABLE 2

| | | Composition (Parts by weight) | | | |
|---|---|---|---|---|---|
| | | PLP1 | PLP2 | PLP3 | PLP4 |
| Monomer | Methyl | 100 | 100 | 100 | 100 |
| | Methacrylate | | | | |
| Internal | Butyl Stearate | 100 | 100 | — | — |
| lubricant | Stearyl Alcohol | — | — | 100 | 100 |
| Ultrahydrophobe | Hexadecane | — | 3 | — | 3 |
| Emulsifier | Sodium | 0.3 | 0.2 | 0.2 | 0.2 |
| | Laurylsulfate | | | | |
| Initiator | Laurylperoxide | 0.1 | 0.1 | 0.2 | 0.1 |

| | | | | |
|---|---|---|---|---|
| Deionized Water | 500 | 500 | 500 | 500 |
| Polymerization Temperature (° C.) | 70 | 70 | 90 | 80 |
| Number-average | 21.4 | 22.3 | 10.4 | 25.8 |
| Molecular weight (×10⁴) | | | | |
| Particle size (nm) | 418 | 542 | 559 | 601 |

### EXAMPLES 1 TO 9

A dried powder mixture is obtained by adding 1 part by weight of the processing aid PEP containing a plasticizer and 1 part by weight of a stabilizer to 100 parts by weight of the polyvinyl chloride resin, and mixing them, introduced into a Hakke torque rheomixer at a certain amount, and then melted at 180° C. at 30 rpm. The mechanical load appearing during the melting is recorded, and gelation times are measured, as shown in the following table 3.

### EXAMPLES 10 TO 13

A dried powder mixer is obtained by adding 1 part by weight of the processing aid PLP containing the internal lubricant and 1 part by weight of a stabilizer, which is an additive needed to process a vinyl chloride resin, to 100 parts by weight of a polyvinyl chloride resin, introduced into a Hakke torque rheomixer at a certain amount, and then melted at 180° C. at 30 rpm. The mechanical loads appearing during the melting are recorded, and gelation times are measured, as shown in table 4.

### COMPARATIVE EXAMPLE 1

In order to compare the processing aid of the present invention with the conventional processing aid, a dried powder mixer is obtained in the same manner as in the example 1, except that the conventional processing aid, polymethacrylate (PMMA), prepared by the method disclosed in Korean Patent Publication No. 1999-0022602 is used instead of the processing aid of the example 1. Measured gelation times are shown in the following tables 3 and 4.

### COMPARATIVE EXAMPLE 2

A dried powder mixer is obtained in the same manner as in the example 1, except that the processing aid is not used in the example 1.

### COMPARATIVE EXAMPLE 3

A dried powder mixer is obtained in the same manner as in the example 1, except that the plasticizer, dioctylphthalate (DOP), is used alone instead of the processing aid in the example 1.

### COMPARATIVE EXAMPLE 4

A dried powder mixer is obtained in the same manner as in the example 1, except that a mixture of the plasticizers DOP and polymethyl is used instead of the processing aid in the example 1.

### COMPARATIVE EXAMPLE 5

A dried powder mixer is obtained in the same manner as in the example 10, except that the internal lubricant butylstearate is used alone instead of the processing aid of the example 10. Measured gelation time is shown in the following table 4.

### COMPARATIVE EXAMPLE 6

A dried powder mixer is obtained in the same manner as in the example 10, except that the internal lubricants butylsterate and polymethyl methacrylate are used instead of the processing aid of the example 10. Measured gelation time is shown in the following table 4.

TABLE 3

| | Examples | | | | | | | | | Comparative Examples | | | |
|---|---|---|---|---|---|---|---|---|---|---|---|---|---|
| | 1 | 2 | 3 | 4 | 5 | 6 | 7 | 8 | 9 | 1 | 2 | 3 | 4 |
| Processing aid | PEP1 | PEP2 | PEP2 | PEP3 | PEP4 | PEP5 | PEP6 | PEP7 | PEP8 | PMMA | No | DOP | DOP/ |
| | | | | | | | | | | | aid | | PMMA |
| Dry method | Spray | Coagu- | Spray | Spray | Coagu- | Coagu- | Coagu- | Coagu- | Coagu- | Spray | — | — | Spray |
| | | lation | | | lation | lation | lation | lation | lation | | | | |
| Gelation Time | 121 | 123 | 124 | 125 | 125 | 124 | 126 | 110 | 108 | 150 | 180 | 181 | 148 |
| (Second) | | | | | | | | | | | | | |

TABLE 4

| | Examples | | | | Comparative Examples | | | |
|---|---|---|---|---|---|---|---|---|
| | 10 | 11 | 12 | 13 | 1 | 2 | 5 | 6 |
| Processing aid | PLP1 | PLP2 | PLP2 | PLP3 | PMMA | No | Butyl | Butyl |
| | | | | | | aid | staterate | stearate/ |
| | | | | | | | | PMMA |
| Dry method | Spray | Coagulation | Spray | Spray | Spray | — | — | Spray |
| Gelation time | 119 | 118 | 120 | 124 | 15 | 180 | 180 | 156 |
| (second) | | | | | | | | |

As shown in table 3 and table 4, it is revealed that if the processing aid containing a plasticizer or an internal lubricant of the example 1 is used, its gelation time is reduced by 30 seconds when compared to that of the comparative example 1 in which the conventional processing aid, polymethyl methacrylate polymer, is used, indicating that the processing aid of the present invention has the enhanced physical properties.

In the comparative examples 3 to 6, it is observed whether or not the plasticizer or the internal lubricant affects the gelation time if the plasticizer or the internal lubricant is used alone, or if the plasticizer is mixed with a processing aid manufactured by the conventional method. The plasticizer or the internal lubricant does not enhance the processibility when it is used alone, and if the plasticizer or the internal lubricant is added and mixed with the processing aid after the processing aid is added to the resin, the processibility is not largely improved when compared to that of the conventional processing aid. Accordingly, it is revealed that the processing aid and the plasticizer or the internal lubricant can enhance the processibility only when the processing aid is manufactured using a composition obtained by polymerizing the processing aid and the plasticizer or the internal lubricant.

In order to attain the same expected effect, although the plasticizer or the internal lubricant is introduced into the vinyl chloride resin together with the processing aid during the dry-blending process, or blended with the vinyl chloride resin after simply mixed with the methyl methacrylate polymer, the effect as provided by the present invention is not obtained. The reason is why that an amount of the plasticizer or the internal lubricant reacting with the processing aid is reduced, and the plasticizer or the internal lubricant is mixed with the entire vinyl chloride resin, or only a small amount of the plasticizer or the internal lubricant is locally reacted with the processing aid, but not reacted with other parts of the resin, resulting in the deteriorated effect of the plasticizer or the internal lubricant.

As observed in the examples 1, 2, 10 and 11, it is revealed that the dry powders prepared by the spray-drying method and the coagulation-drying method exhibit the same gelation time within the test error range, indicating that difference in the powdering process does not affect the effect of the processing aid.

Referring to the examples 5 and 6 in which the methacrylte-based plasticizer is used and the examples 1, 4, and 7 in which the phthalate-based plasticizer is used, it is found that the methacrylate-based plasticizer shortens the gelation time like the phthalate-based plasticizer does. In case of using the processing aid having the number-average molecular weight of 2,000,000 which is used in the examples 8 and 9, the gelation time is more greatly shortened comparative to the use of the processing aid having the number-average molecular weight of 1,000,000 used in the examples 1 to 7 15 seconds.

As described above, the processing aid containing the plasticizer or the internal lubricant according to the present invention can greatly reduce the processing time of the vinyl chloride resin, and improve the processibility of the vinyl chloride resin.

While the invention has been shown and described with reference to certain embodiments thereof, it will be understood by those skilled in the art that various changes in form and details may be made therein without departing from the spirit and scope of the invention as defined by the appended claims.

1. A processing aid containing a plasticizer or an internal lubricant for vinyl chloride resin within methyl methacrylate-based polymer particles.

2. The processing aid according to claim 1, wherein the processing aid for vinyl chloride resin is polymethylmethacrylate.

3. The processing aid according to claim 1, the processing aid for vinyl chloride resin further comprises a polymer obtained by copolymerizing a monomer having unsaturated double bonds, copolymerizable with a methylmethacrylate monomer, with a methylmethacrylate monomer.

4. The processing aid according to claim 1, wherein the plasticizer or the internal lubricant are used at an amount of 5 to 900 parts by weight, based on 100 parts by weight of the processing aid.

5. The processing aid according to claim 1, wherein the plasticizer is selected from the group consisting of phthalate derivatives having C₃ to C₂₀ carbon atoms, fatty acid ester derivatives having C₃ to C₂₀ carbon atoms, mellitate derivatives having C₃ to C₃₀ carbon atoms, phosphate derivatives having C₁ to C₂₀ carbon atoms, epoxy derivatives, soybean oils and polyethylene derivatives.

6. The processing aid according to claim 5, wherein the phthalate derivatives having C₃ to C₂₀ carbon atoms are selected from the group consisting of di(2-ethylhexyl)phthalate, di(n-octyl)phthalate, diiosononyl phthalate, diisodecyl phthalate, dimethyl phthalate, diethyl phthalate, diisobutyl phthalate, dibutyl phthalate, diheptyl phthalate, dinonyl phthalate, ditridecyl phthalate, butylbenzyl phthalate and butylphthalyl butylglycol; the fatty acid ester derivatives having C₃ to C₂₀ carbon atoms are selected from the group consisting of dioctyl adipate, diisononyl adipate, diisodecyl adipate, dioctyl azelate, dioctyl cebacate, methylacetylicinolate, dibutylglycol adipate, di(2-ethylhexyl) malate, dibutyl malate, dibutylacetyl fumarate, acetyltriethyl citrate, acetyl 2-ethylhexyl citrate, triethyl citrate, acetyltributyl citrate and acetyltriethyl citrate; the phosphate derivatives having C₁ to C₂₀ carbon atoms are selected from the group consisting of triceresyl phosphate, triphenyl phosphate, trioctyl phosphate, triisopropyl phosphate, tribetachloroethyl phosphate, octyldiphenyl phosphate, and tridichloropropyl phosphate; the mellitate derivatives having C₃ to C₃₀ carbon atoms are selected from the group consisting of trioctyl mellitate and triisodecyl mellitate; and the epoxy derivative is selected from the group consisting of epoxy fatty acid ester and epoxidated grease derivatives.

7. The processing aid according to claim 1, wherein the internal lubricant is selected from the group consisting of fatty acid ester derivatives, fatty acid-based derivatives and their metal salts having C₁₀ to C₂₀ carbon atoms, fatty acid alcohols and their metal salts having C₆ to C₂₀ carbon atoms, ester compounds of polyol and fatty acid, and fatty acid amid derivatives having C₁₀ to C₂₃ carbon atoms.

8. The processing aid according to claim 3, wherein the monomer is selected from the group consisting of methacrylate derivatives, acrylate derivatives, acryl acid derivatives, methacrylonitrile derivatives, styrene, styrene derivatives, acrylonitrile derivatives, vinylester derivatives, halogenized vinyl derivative butadiene, isoprene, maleic anhydride, and fumaric acid.

9. The processing acid according to claim 1, wherein the processing aid has a particle size of 100 to 1500 nm.

10. The processing acid according to claim 1, wherein molecular weight of the processing aid ranges from 100,000 to 10,000,000.

11. A method for manufacturing a processing aid, comprising:
mixing and homogenizing a monomer having unsaturated double bonds and capable of being polymerized by free radicals, a ultrahydrophobe, a plasticizer or an internal lubricant, an emulsifier, an initiator and deionized water so as to obtain a miniemulsion; and
polymerizing the miniemulsion by heating.

12. A method for preparing a processing aid, comprising:
mixing and homogenizing a monomer having unsaturated double bonds and capable of being polymerized by free radicals, a plasticizer or an internal lubricant, an emulsifier, an initiator and deionized water so as to obtain a miniemulsion; and
polymerizing the miniemulsion by heating,
wherein the plasticizer or the internal lubricant has a solubility in water of 5×10⁻⁶ g/g or less at 25° C.

13. The method according to claim 11, wherein the miniemulsion further comprises a copolymer monomer copolymerizable with the monomer in the step of obtaining the miniemulsion.

14. The method according to claim 11, wherein the homogenizing step is performed by using a microfluidizer, an ultrasonifier, a Manton-Gaulin homogenizer or an omni-mixer.

15. The method according to claim 11, wherein the emulsion has a particle size of 100 to 1600 nm.

16. The method according to claim 11, wherein the emulsion includes 5 to 900 parts by weight of the plasticizer or the internal lubricant, 0.05 to 3 parts by weight of the emulsifier, 0.01 to 0.3 parts by weight of the initiator, 100 and 500 parts by weight of the distilled water, based on 100 parts by weight of the monomer.

17. The method according to claim 11, wherein the ultrahydrophobe has a solubility in water 5×10⁻⁶ g/g or less at 25° C., and is at least one material selected from the group consisting of aliphatic hydrocarbons having C₁₂ to C₂₀ carbon atoms, aliphatic alcohols having C₁₂ to C₂₀ carbon atoms, acrylate composed of alkyl groups having C₁₋₂ to C₂₀ carbon atoms, alkyl mercaptan having C₁₂ to C₂₀ carbon atoms, organic dyes, fluorinated alkane, silicon oils, natural oils, synthetic oils, oligomers having a molecular weight of 1,000 to 500,000, and polymers having a molecular weight of 1,000 to 500,000.

18. The method according to claim 11, wherein the ultrahydrophobe has an amount of less than 10 parts by weight, based on 100 parts by weight of the monomer.

19. The method according to claim 11, wherein the emulsifier is at least one material selected from the group consisting of anionic emulsifiers, cationic emulsifiers and nonionic emulsifiers.

20. The method according to claim 11, wherein the initiator is at least one material selected from the group consisting of persulfate-based initiators, peroxides, peroxide-based initiators, azo-based initiators and redox-based initiators.

21. The method according to claim 11, wherein the plasticizer is selected from the group consisting of phthalate derivatives having C₃ to C₂₀ carbon atoms, fatty acid ester derivatives having C₃ to C₂₀ carbon atoms, mellitate derivatives having C₃ to C₃₀ carbon atoms, phosphate derivatives having C₁ to C₂₀ carbon atoms, epoxy derivatives, soybean oils and polyethylene derivatives.

22. The method according to claim 21, wherein the phthalate derivatives having C₃ to C₂₀ carbon atoms are selected from the group consisting of di(2-ethylhexyl)phthalate, di(n-octyl)phthalate, diiosononyl phthalate, diisodecyl phthalate, dimethyl phthalate, diethyl phthalate, diisobutyl phthalate, dibutyl phthalate, diheptyl phthalate, dinonyl phthalate, ditridecyl phthalate, butylbenzyl phthalate and butylphthalyl butylglycol; the fatty acid ester derivatives having C₃ to C₂₀ carbon atoms are selected from the group consisting of dioctyl adipate, diisononyl adipate, diisodecyl adipate, dioctyl azelate, dioctyl cebacate, methylacetylicinolate, dibutylglycol adipate, di(2-ethylhexyl) malate, dibutyl malate, dibutylacetyl fumarate, acetyltriethyl citrate, acetyl 2-ethylhexyl citrate, triethyl citrate, acetyltributyl citrate and acetyltriethyl citrate; the phosphate derivatives having C₁ to C₂₀ carbon atoms are selected from the group consisting of triceresyl phosphate, triphenyl phosphate, trioctyl phosphate, triisopropyl phosphate, tribetachloroethyl phosphate, octyldiphenyl phosphate, and tridichloropropyl phosphate; the mellitate derivatives having C₃ to C₃₀ carbon atoms are selected from the group consisting of trioctyl mellitate and triisodecyl mellitate; and
the epoxy derivative is selected from the group consisting of epoxy fatty acid ester and epoxidated grease derivatives.

23. The method according to claim 11, wherein the internal lubricant is selected from the group consisting of fatty acid ester derivatives, fatty acid-based derivatives and their metal salts having C₁₀ to C₂₀ carbon atoms, fatty acid alcohols and their metal salts having C₆ to C₂₀ carbon atoms, ester compounds of polyol and fatty acid, and fatty acid amid derivatives having C₁₀ to C₂₃ carbon atoms.

24. The method according to claim 11, further comprising:
forming dried particles using a spray-drying method after the step of polymerizing a miniemulsion by heating, or coagulating and drying a miniemulsion to remove moisture.

25. The method according to claim 12, wherein the miniemulsion further comprises a copolymer monomer copolymerizable with the monomer in the step of obtaining the miniemulsion.

26. The method according to claim 12, wherein the homogenizing step is performed by using a microfluidizer, an ultrasonifier, a Manton-Gaulin homogenizer or an omni-mixer.

27. The method according to claim 12, wherein the emulsion has a particle size of 100 to 1600 nm.

28. The method according to claim 12, wherein the emulsion includes 5 to 900 parts by weight of the plasticizer or the internal lubricant, 0.05 to 3 parts by weight of the emulsifier, 0.01 to 0.3 parts by weight of the initiator, 100 and 500 parts by weight of the distilled water, based on 100 parts by weight of the monomer.

29. The method according to claim 12, wherein the emulsifier is at least one material selected from the group consisting of anionic emulsifiers, cationic emulsifiers and nonionic emulsifiers.

30. The method according to claim 12, wherein the initiator is at least one material selected from the group consisting of persulfate-based initiators, peroxides, peroxide-based initiators, azo-based initiators and redox-based initiators.

31. The method according to claim 12, wherein the internal lubricant is selected from the group consisting of fatty acid ester derivatives, fatty acid-based derivatives and their metal salts having C₁₀ to C₂₀ carbon atoms, fatty acid alcohols and their metal salts having C₆ to C₂₀ carbon atoms, ester compounds of polyol and fatty acid, and fatty acid amid derivatives having C₁₀ to C₂₃ carbon atoms.

32. The method according to claim 12, further comprising:
forming dried particles using a spray-drying method after the step of polymerizing a miniemulsion by heating, or coagulating and drying a miniemulsion to remove moisture.
